(19) United States
(12) Patent Application Publication
(10) Pub. No.: US 2024/0370363 A1
(43) Pub. Date: Nov. 7, 2024

(54) KEY-VALUE BASED DATA STORAGE DEVICE AND OPERATION METHOD THEREOF

(71) Applicants: SK hynix Inc., Icheon-si (KR); Sogang University Research and Business Development Foundation, Seoul (KR)

(72) Inventors: Seungjin LEE, Seoul (KR); Changgyu Lee, Seoul (KR); Youngjae Kim, Seoul (KR); Inhyuk Park, Icheon-si (KR); Woo Suk Chung, Icheon-si (KR)

(21) Appl. No.: 18/513,233

(22) Filed: Nov. 17, 2023

(30) Foreign Application Priority Data
May 2, 2023 (KR) 10-2023-0057331

(51) Int. Cl. G06F 12/02

(52) U.S. Cl. CPC G06F 12/0246

(57) ABSTRACT

A key-value (KV) based data storage device includes a first memory, a second memory, a key buffer, and a controller. The first memory stores a first table, the second memory includes a Log-Structured Merge (LSM) tree area storing a plurality of second tables forming an LSM tree structure and a value log area storing a value corresponding to a key, and the key buffer stores one or more prefetched second tables corresponding to a key. The controller is configured to process a range query command by prefetching a second table adjacent to a previously-prefetched second table from the second memory and storing the second table in the key buffer when a number of unqueried keys in the previously-prefetched second table is smaller than a predetermined number. Processing the range query command may also include prefetching values from the value log area into a value buffer.

### CROSS-REFERENCE TO RELATED APPLICATION

The present application claims priority under 35 U.S.C. § 119 (a) to Korean Patent Application No. 10-2023-0057331, filed on May 2, 2023, which is incorporated herein by reference in its entirety.

### BACKGROUND

### 1. Technical Field

Various embodiments generally relate to a key-value based data storage device and an operation method thereof, and more particularly, to a key-value based data storage device that efficiently processes a range query command by performing a prefetch operation and an operation method thereof.

### 2. Related Art

A key-value based data storage device is a type of data storage device that processes values using keys, and performs a write operation, a read operation, a delete operation, and a scan operation.

A range query is a frequently used operation in a database operation, and an operation of reading a key-value pair corresponding to a specific key range is performed for processing a range query.

Conventional key-value data storage devices based on NAND flash memory frequently access NAND flash memory to read keys and data while processing range query commands. Because it takes a relatively long time to access a NAND flash memory, processing time of a range query command increases and overall performance deteriorates as a result. In particular, when an operation of reading a key from the NAND

flash memory is additionally performed before reading a value, latency is further increased.

### SUMMARY

In accordance with an embodiment of the present disclosure, a key-value based data storage device may include a first memory configured to store a first table; a second memory configured to store a Log-Structured Merge (LSM) tree area storing a plurality of second tables forming an LSM tree structure and a value log area and to store a value corresponding to a key; a key buffer configured to store one or more prefetched second tables corresponding to a key; and a controller configured to control processing a range query command, wherein the processing the range query command comprises performing a key prefetch operation when a number of unqueried keys in a first prefetched second table is smaller than a predetermined number, the key prefetch operation comprising reading from the second memory a second table adjacent in the LSM tree structure to the first prefetched second table and storing that adjacent second table as a second prefetched second table in the key buffer.

In accordance with an embodiment of the present disclosure, an operation method of a key-value (KV) based data storage device, the operation method may include processing a first command to read a value corresponding to a start key corresponding to a range query command; and processing a plurality of second commands subsequent to the first command to read values corresponding to a plurality of keys subsequent to the start key, wherein processing the first command includes: reading one or more second tables from a Log-Structured Merge (LSM) tree area in a second memory of the KV based storage device, the one or more second tables including respective start keys; storing the one or more second tables as prefetched second tables in a key buffer of the KV based storage device; determining a data offset corresponding to a start key in a first table in a first memory of the KV based storage device or in the one or more prefetched second tables stored in the key buffer; and reading a first value corresponding to the data offset from a value log area in the second memory.

### BRIEF DESCRIPTION OF THE DRAWINGS

The accompanying figures, where like reference numerals refer to identical or functionally similar elements throughout the separate views, together with the detailed description below, are incorporated in and form part of the specification, and serve to further illustrate various embodiments, and explain various principles and advantages of those embodiments.

FIG. 1 illustrates a key-value based data storage device according to an embodiment of the present disclosure.

FIG. 2 illustrates a control circuit according to an embodiment of the present disclosure.

FIG. 3 illustrates an operation of a control circuit according to an embodiment of the present disclosure.

FIGS. 4A and 4B illustrate a key prefetch operation of a control circuit according to an embodiment of the present disclosure.

FIGS. 5A and 5B illustrates a value prefetch operation of a control circuit according to an embodiment of the present disclosure.

### DETAILED DESCRIPTION

The following detailed description references the accompanying figures in describing illustrative embodiments consistent with this disclosure. The embodiments are provided for illustrative purposes and are not exhaustive. Additional embodiments not explicitly illustrated or described are possible. Further, modifications can be made to the presented embodiments within the scope of teachings of the present disclosure. The detailed description is not meant to limit this disclosure. Rather, the scope of the present disclosure is defined in accordance with claims and equivalents thereof. Also, throughout the specification, reference to “an embodiment” or the like is not necessarily to only one embodiment, and different references to any such phrase are not necessarily to the same embodiment(s).

Hereinafter, a key-value (KV) based solid state drive (SSD) that manages keys using a Log-Structured Merge (LSM) tree structure and stores values corresponding to keys in a value log area separate from the LSM tree area is taken as an example.

Because the KV SSD itself, which manages keys using an LSM tree structure and stores values in a separate log area, is well known by prior articles such as Lee, Chang-Gyu, et al. “ILSM-SSD: An intelligent LSM-tree based key-value SSD for data analytics.” 2019 IEEE 27th International Symposium on Modeling, Analysis, and Simulation of Computer and Telecommunication Systems (MASCOTS). IEEE, 2019, repetitive description of the prior art will be omitted.

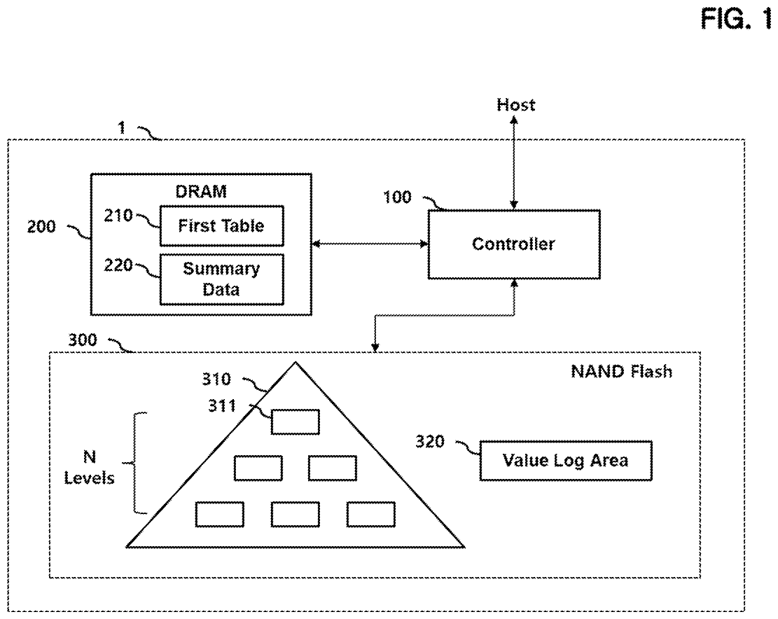

FIG. 1 is a block diagram showing a KV SSD 1 according to an embodiment of the present disclosure.

The KV SSD 1 includes a controller 100, a dynamic random access memory (DRAM) 200, and a NAND flash memory 300.

The controller 100 may perform a read, a write, or an erase operations by receiving a command provided from a host. Because this is disclosed in the aforementioned article, repetitive explanation is omitted.

The controller 100 additionally processes a range query command and controls a prefetch operation for a key, a prefetch operation for a value, or both during this process.

Hereinafter, a prefetch operation for a key is referred to as a key prefetch operation, and a prefetch operation for a value is referred to as a value prefetch operation. These will be described in detail below.

The controller 100 may control the DRAM 200 and the NAND flash memory 300 while processing a range query command.

The DRAM 200 stores a first table 210 and summary data 220. The first table 210 may be referred to as MemTable and the summary data 220 may be referred to as Summary.

The NAND flash memory 300 includes an LSM tree area 310 for storing keys and a value log area 320 for storing values corresponding to the keys.

The LSM tree area 310 includes a plurality of second tables 311, and the plurality of second tables are arranged in a tree structure having N levels, where N is a natural number. A second table may be represented as a Sorted String Table (SSTable). Each second table stores a plurality of keys and offsets corresponding thereto.

The value log area 320 is an area for storing values corresponding to keys, and an address of a value corresponding to a key may be calculated using an offset corresponding to that key and a base address.

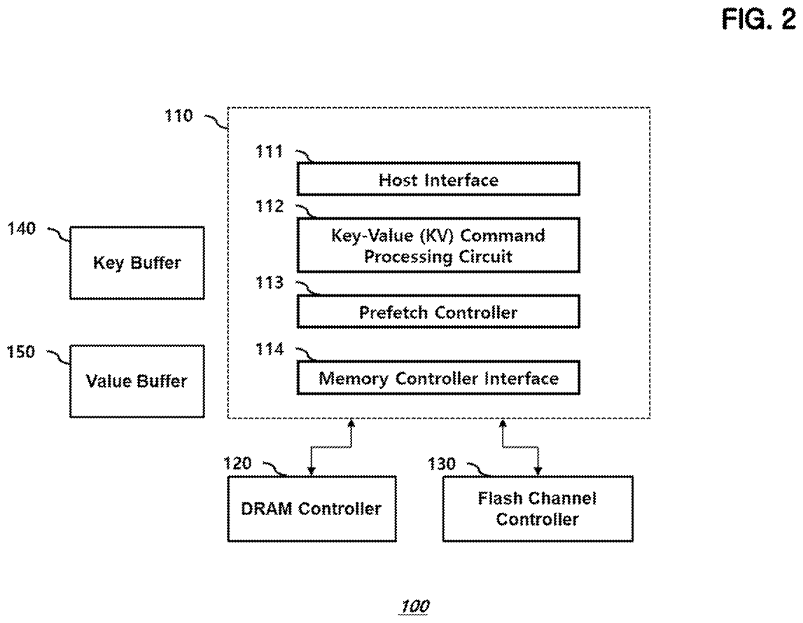

FIG. 2 is a block diagram showing a controller 100 according to an embodiment of the present disclosure.

The controller 100 includes a control circuit 110, a DRAM controller 120, a flash channel controller 130, a key buffer 140, and a value buffer 150.

The control circuit 110 decodes a range query command and controls a key prefetch operation and a value prefetch operation.

The control circuit 110 may be comprised of hardware, software, or a combination thereof.

The DRAM controller 120 controls a read operation or a write operation of the DRAM 200 according to the control of the control circuit 110.

The flash channel controller 130 controls a read operation, a write operation, or an erase operation of the NAND flash memory 300 under the control of the control circuit 110.

In this embodiment, the flash channel controller 130 controls one or more channels, and a plurality of flash memories are connected to each channel.

Because the DRAM controller 120 and the flash channel controller 130 themselves can be the same as conventional ones, repetitive descriptions thereof will be omitted.

The key buffer 140 stores a plurality of second tables prefetched from the LSM tree area 310. Hereinafter, a second table stored in the key buffer 140 may be referred to as a prefetched second table. In embodiments, the key buffer 140 resides in memory that is substantially faster than the NAND Flash memory 300 of FIG. 1; for example, the key buffer 140 may reside in dedicated high-speed memory of the controller circuit 110, or in the DRAM 200 of FIG. 1, but embodiments are not limited thereto.

The value buffer 150 stores a plurality of values prefetched from the value log area 320. Hereinafter, a value stored in the value buffer 150 may be referred to as a prefetched value. In embodiments, the value buffer 150 resides in memory that is substantially faster than the NAND Flash memory 300 of FIG. 1; for example, the value buffer 150 may reside in dedicated high-speed memory of the controller circuit 110, or in the DRAM 200 of FIG. 1, but embodiments are not limited thereto.

When a value is prefetched, a value corresponding to a key located at a predetermined distance D from a current key is prefetched. At this time, D can be referred to as a prefetch distance, where D is a natural number. This will be disclosed in detail below.

The control circuit 110 includes a host interface 111, a KV command processing circuit 112, a prefetch controller 113, and a memory controller interface 114.

The host interface 111 extracts a KV command from a request sent from the host.

For example, the host may send a KV request according to a Non-Volatile Memory express (NVMe) protocol and the host interface 111 extracts the KV command from the KV request according to the NVMe protocol.

The KV command processing circuit 112 can process commands such as PUT and GET, which are general KV commands. Because these commands are well known through the prior art, a repetitive description thereof will be omitted.

In this embodiment, the KV command processing circuit 112 processes a KV command by controlling the prefetch controller 113 and the memory controller interface 114 according to a range query command.

The range query command is a command for reading values corresponding to a range of keys associated with the command, and may include a first command for finding a start key and a plurality of second commands for reading values corresponding to a plurality of keys subsequent to the start key.

The first command may be referred to as a seek command, and the second command may be referred to as a next command.

As described above, the DRAM 200 stores summary data 220, which stores meta information about all of the second tables stored in the LSM tree area 310. The summary data 220 may be protected by supplying emergency power to the DRAM 200 in a power outage situation using an emergency power supply device such as a battery or a super capacitor.

For example, meta information for a second table may include, for example, a level of that second table, an address of that second table, an address of a second table located at a level above the level of that second table, an address of a second table located at level lower than the level of that second table, a plurality of keys stored in that second table, etc. In this example, an address of a second table indicates an address of that second table within the NAND flash memory 300.

In this disclosure, detailed operations by a range query command can be classified as follows.

Hereinafter, a first key for which a range query command is executed is referred to as a start key, a key corresponding to a value being currently read during execution of the range query command is referred to as a current key, and a key next to the current key is referred to as a next key.

### An (a) Operation: Memory Reference and Calculation

When a first command (that is, a seek command) is executed, an (a) operation corresponds to an operation for finding a second table including a start key with reference to the summary data 210 in the DRAM 200 and storing the second table in the key buffer 140. Here, the start key may be the smallest (or lexically first-ordered) key in the first table and the second table that are within the range of keys associated with the range query command.

At this time, if a plurality of second tables including a start key exist in the plurality of levels of the LSM tree area 310, all of them are stored in the key buffer 140 as a plurality of prefetched second tables. In embodiments including a multi-level LSM tree structure, for each level of the LSM tree structure, only the second table in that level having the smallest (or lexically first-ordered) key that falls within the range of keys associated with the range query command is stored in the key buffer 140 as a prefetched second table at this time. The KV command controller 112 selects the smallest (or lexically first-ordered) among the start keys or, when the smallest (or lexically first-ordered) among the start keys is included in multiple second tables, the most recently updated start key among the first table and the plurality of prefetched second tables to use as the start key.

When the second command (that is, a next command) is executed, the (a) operation corresponds to an operation of determining the number of keys that can be queried from a second table.

In this embodiment, when the number of keys that can be queried from the second table is smaller than or equal to a predetermined number, a key prefetch operation for reading a next second table is performed.

Because a second table includes a plurality of keys arranged in order of magnitude, when an array index corresponding to a current key in that second table is referred to as a cursor, the number of keys that can be additionally queried from that second table can be determined using the cursor. For example, if the cursor is the same as the maximum value of an array index for that second table, it means that there are no more keys to query in that second table.

### A (b) Operation: Additional Reading of a Second Table

The (b) operation corresponds to an operation of finding a next second table adjacent to the prefetched second table and storing that next second table in the key buffer 140. In embodiments, the next second table adjacent to the prefetched second table is in a same level of the LSM tree as the prefetched second table. In embodiments, adjacent second tables within a level of the LSM tree have adjacent ranges of keys.

### A (c) Operation: Increment and Comparison

The (c) operation corresponds to an operation of searching for a key next to the current key in the first table and one or more prefetched second tables and finding the smallest key among searched keys. If there are multiple smallest keys, the most recently updated smallest key is selected as the next key. At this time, position of respective cursors in the one or more second tables including the smallest key are updated.

### A (d) Operation: Reading a Value

The (d) operation corresponds to an operation of reading a value corresponding to the current key from the value log area 320. In embodiments including value prefetch, the (d) operation may instead read the value corresponding to the current key from the value buffer 150 as appropriate.

### An (e) Operation: Host Delivery

The (e) operation corresponds to an operation of transferring a value read in the (d) operation to the host. In embodiments, the current key may be transferred to the host with the value read.

In this embodiment, the waiting time can be reduced by performing a key prefetch operation where a second table is read in advance. In addition, in this embodiment, the waiting time can be further reduced by performing a value prefetch operation in which a value is read in advance.

Hereinafter, a key prefetch operation and a value prefetch operation will be described in more detail.

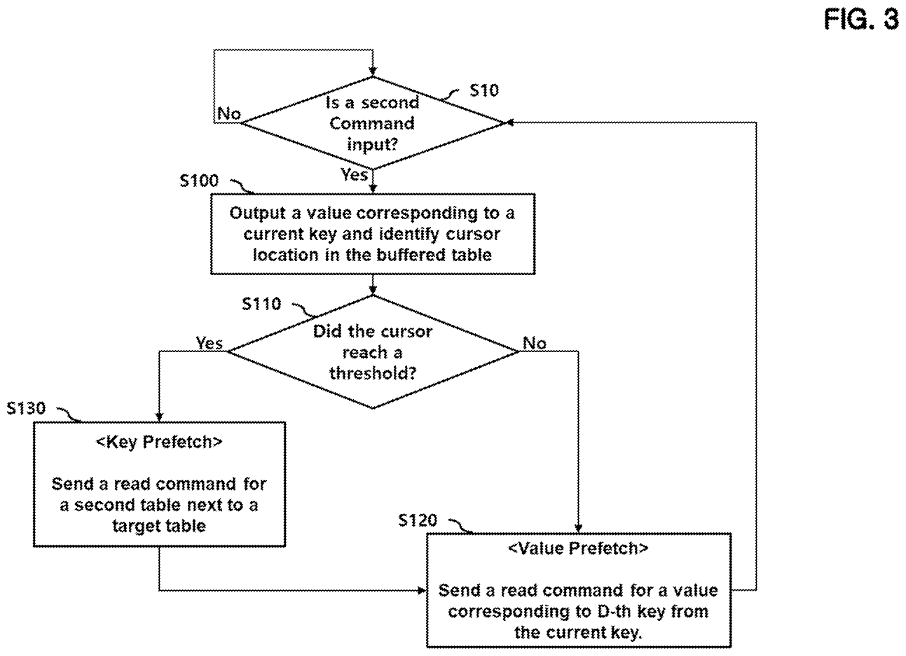

FIG. 3 is a flowchart illustrating an operation of the controller 100 according to an embodiment of the present disclosure.

In the present embodiment, while processing a range query command, a plurality of second commands (that is, next commands) are executed after a first command (that is, a seek command) is executed. FIG. 3 corresponds to a case where a second command is executed after a first command is executed.

Hereinafter, executing a first command is disclosed before disclosing how to process a second command.

According to the first command, the KV command processing circuit 112 refers to the summary table 220 and reads a second table including a start key and stores it in the key buffer 140.

In a KV SSD using an LSM tree structure, there may be a plurality of second tables including respective start key for a plurality of levels of the LSM tree structure. In this case, all of the second tables including the start key may be stored in the key buffer 140. In an embodiment, the start keys for each level may have different key values, with each start key for each level being the smallest (or lexically first-ordered) key in that level that is within the range of key values associated with the range query command.

Then, the KV command processing circuit 112 compares a plurality of start keys in the first table 210 and the key buffer 140 to select as the current start key the most recently updated start key that has the smallest (or lexically first-ordered) value among all the start keys.

The KV command processing circuit 112 executes a read operation corresponding to the current start key. A value corresponding to the current start key (and, in embodiments, the current start key) is output to the host.

In this embodiment, a value prefetch operation may be selectively performed. A prefetch distance for a value prefetch operation performed when the first command is executed may differ from a prefetch distance for a value prefetch operation performed when the second command is executed.

A value prefetch operation performed when the first command is executed is like the following. In an embodiment including a plurality of start keys respectively corresponding to different levels of the LSM tree, the value prefetch operation may be performed only for the current start key selected as described above. In another embodiment including the plurality of start keys respectively corresponding to the different levels of the LSM tree, the value prefetch operation may be performed for the start key for each level. In another embodiment including the plurality of start keys respectively corresponding to the different levels of the LSM tree, the value prefetch operation may be performed for the start key for each level unless that start key was updated less recently than another start key having the same key value.

In the value prefetch operation of the first command, if a prefetch distance is indicated as D, the prefetch controller 113 controls the KV command processing circuit 112 to read values corresponding to keys from a key next to the start key to a D-th key from the start key (or, when there are less than D keys after the start key in the second table thereof, all the remaining keys in that second table).

For example, when D is 2, the prefetch controller 113 controls the KV command processing circuit 112 to perform read operations for the two keys next to the start key.

In order to find a next key after the current key, the above-described (c) operation is performed. That is, one or more tables including a current key is found among the first table and a plurality of prefetched second tables, and all keys next to the current key of the one or more tables are compared. As a result of the comparison, the smallest key is selected as the next key, but if there are a plurality of the smallest keys, the most recently updated key among the plurality of the smallest keys is determined as the next key.

After the processing of the first command, a plurality of second commands received from the host may be executed.

When a second command is executed, because a value corresponding to a current key has been prefetched into the value buffer 150, a value is read therefrom and transmitted to the host. In addition, a value prefetch operation comprising a read operation for one D-th next key from the current key may be performed. When a value prefetch operation is performed as part of processing the first or second command, an association between the prefetched value and the corresponding key may be created, which association may be used to read the value when the corresponding key becomes the current key. For example, in an illustrative embodiment, an offset into the value buffer 150 may be associated with the corresponding key's prefetched second table in the key buffer 140; in some embodiments, the offset into the value buffer 150 may replace the offset into the value log area previously associated with that key in that prefetched second table, along with an indication that the offset replacement has occurred. In another embodiment, the association between the key and the prefetched value may be made in the value buffer 150, such as when value buffer 150 has a cache-like or hash-table like structure.

FIG. 3 shows an operation of the controller when a second command is executed.

First, it is determined whether a second command is input at step S10.

If a second command is not input, the controller waits at step S10, otherwise it moves to the next step S100.

At step S100, first, a value corresponding to a current key is output, and positions of cursors in one or more prefetched second tables are checked

Because a value corresponding to the current key has been prefetched into the value buffer 150, the value can be immediately output.

The cursor indicates the position of the current key. Each second table includes a certain number of keys arranged sequentially, and a position of each key may be indicated by an index. That is, the cursor can be represented as an index corresponding to the current key. As described above, a plurality of second tables corresponding to any one key may exist throughout the levels of the LSM tree structure. The respective cursors of the plurality of second tables may have different values from each other.

After step S100, the controller determines whether the cursor has reached a threshold at step S110.

The threshold is a predetermined index and has a common value for every second table.

A value obtained by subtracting the cursor from the last index of a second table corresponds to the number of keys that can be searched in the future in that second table, and corresponds to the number of remaining keys in that second table.

A value obtained by subtracting the threshold from the last index of a second table may be referred to as a marginal number of remaining keys.

When there are a plurality of second tables corresponding to the current key, it is determined as “Yes” if the cursor reaches the threshold in at least one of that plurality of second tables and it is determined as “No” if the cursor does not reach the threshold in any of that plurality of second tables.

If it is determined as “No” in step S110, a value prefetch operation is performed at step S120. To perform a value prefetch operation, a D-th key from the current key is determined, and a value corresponding to the D-th key from the current key is read and stored in the value buffer 150.

At this time, the D-th key from the current key is preferably stored in the prefetched table. Accordingly, it is preferable to set the threshold so that the marginal number of remaining keys is greater than or equal to D.

If “Yes” is determined in step S110, a key prefetch operation is performed at step S130.

When there are a plurality of second tables, a second table on which the cursor reaches the threshold is referred to as a target table.

A plurality of second tables included in the same level in the LSM tree structure are arranged in the order of key. Accordingly, the prefetch controller 113 may select a second table including a key next to the target table with reference to the summary data 220. The prefetch controller 113 controls the KV command processing circuit 112 to prefetch a second table next to (that is, subsequent to) the target table, and stores the prefetched second table in the key buffer 140.

If the target table is the last second table of a corresponding level, the key prefetch operation is not performed for the corresponding level.

If there are multiple target tables, a key prefetch operation described above may be performed for each of the multiple target tables.

Thereafter, the above-described value prefetch operation is performed at step S120, and the process moves to step S10.

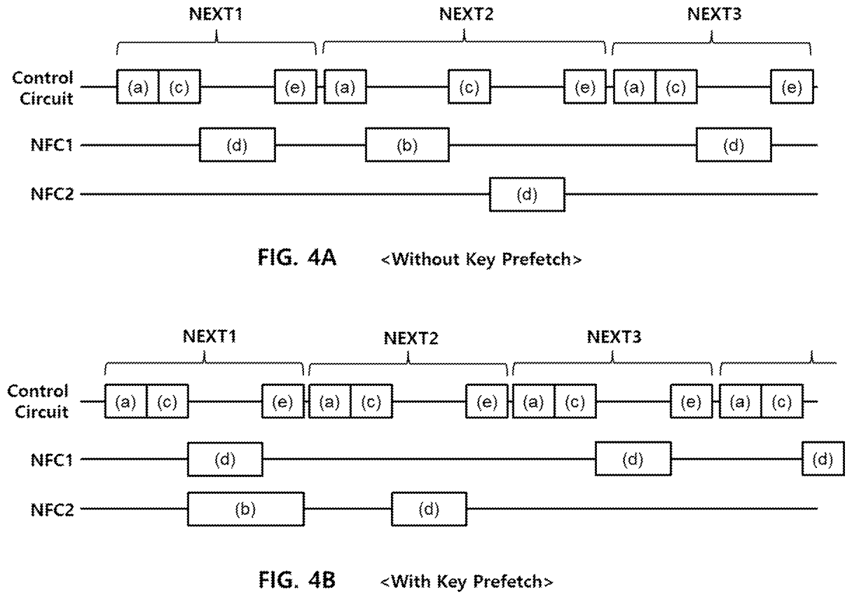

FIGS. 4A and 4B are diagrams showing the effect of the key prefetch operation of the present disclosure.

The diagram of FIGS. 4A and 4B illustrate a case in which the second commands NEXTs for a range query command are being processed.

FIGS. 4A and 4B assumes that NAND flash memories are distributed over two channels NFC1 and NFC2. That is, the flash channel controller 130 independently controls the NAND flash memory for the two channels NFC1 and NFC2. In addition, operations indicated with (a), (b), (c), (d), and (e) in FIGS. 4A and 4B respectively represents the (a) operation, (b) operation, (c) operation, (d) operation, and (e) operation described above.

FIG. 4A shows an operation in the case where a key prefetch operation is not performed.

A first second command NEXT1 illustrates a case wherein the current key exists in the prefetched second table in the (a) operation.

Accordingly, an offset corresponding to the current key is read from the prefetched second table in the (c) operation, a value is read from the NAND flash memory 300 using the offset in the (d) operation, and the value is transmitted to the host in the (e) operation.

The second second command NEXT2 illustrates a case wherein the current key does not exist in a prefetched second table in the (a) operation.

Accordingly, the next second table is read from the NAND flash memory 300 and stored as a prefetched second table in the (b) operation, and an offset corresponding to the current key is read from the prefetched second table in the (c) operation, a value is read from the NAND flash memory 300 by using the offset in the (d) operation and the value is transmitted to the host in the (e) operation.

The third second command NEXT3 is processed like the first second command NEXT1.

In this way, when the second second command NEXT2 is executed, an operation of reading the second table must be performed before a value is read, so the waiting time until a value is delivered to the host (that is, the latency of the second second command NEXT2) increases.

FIG. 4B shows a case where a key prefetch operation is performed.

Accordingly, during the (a) operation, it is determined whether the cursor has reached the threshold.

The first second command NEXT1 illustrates a case wherein the cursor has reached the threshold in the (a) operation.

Accordingly, the offset corresponding to the current key is first read from the prefetched second table in the (c) operation, a value is read from the NAND flash memory 300 using the offset in the (d) operation, and the value is transmitted to the host in the (e) operation.

In addition, a key prefetch operation of reading a second table next to (that is, subsequent to) the target table from the NAND flash memory 300 and storing it in the key buffer 140 (b) is performed.

The second second command NEXT2 and the third second command NEXT3 illustrate cases wherein the cursor does not reach the threshold.

Because this case is the same as described with respect to the first second command NEXT1 of FIG. 4A, the description will not be repeated.

When the key prefetch operation is performed, the waiting time is reduced because the operation of reading the second table before reading the value does not need to be performed when processing a second command.

In FIG. 4B, for the processing of the first second command NEXT1 it is indicated that the operation (d) of reading a value is performed using the NAND flash memory connected to the first channel NFC1, and the operation of reading the second table (b) is performed using the NAND flash memory connected to the second channel NFC2.

If the NAND flash memory in which the second table is stored and the NAND flash memory in which a value is stored are connected to the same channel, the two operations (b) and (d) must be sequentially performed, and a time delay may occur during this process.

However, the time delay due to such channel contention is a problem that can be overcome by efficiently performing data allocation, which is outside the scope of the present invention.

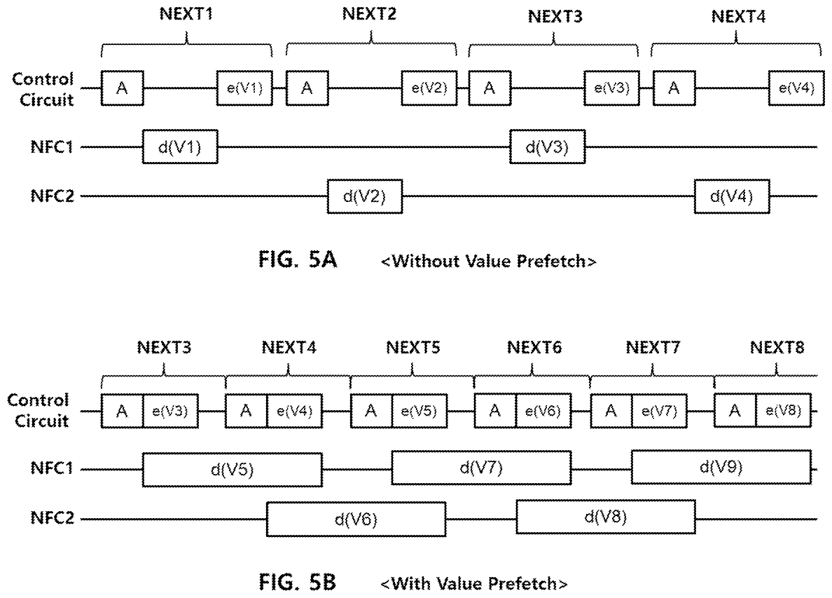

FIGS. 5A and 5B are diagrams showing the effect of the value prefetch operation of the present disclosure.

The diagrams of FIGS. 5A and 5B show processes in which a series of second commands NEXTs of a range query command are processed.

In FIGS. 5A and 5B, A corresponds to operations (a), (b), and (c) of FIGS. 4A and 4B, and d and e correspond to (d) and (e) of FIGS. 4A and 4B, respectively.

In FIGS. 5A and 5B, it is assumed that D is 2.

When a value prefetch operation is not performed as in FIG. 5A, the control circuit 110 waits while reading a value from the NAND flash memory 300 before performing the (e) operation after the A operation.

Taking the first second command NEXT1 as an example, the control circuit 110 may perform the A operation, wait while the (d) operation is performed in the NAND flash memory 300, and then perform the (e) operation.

In contrast, in the case wherein the value prefetch operation has been performed shown in FIG. 5B, after performing the A operation in the control circuit 110, the (e) operation can be performed using the prefetched value without waiting for the operation of the NAND flash memory. This can reduce waiting time.

Taking the third second command NEXT3 in FIG. 5B as an example, after the A operation is performed, the (e) operation is performed using the corresponding prefetched value.

At this time, because the control circuit 110 transmits the value stored in the value buffer 150 to the host, the waiting time is reduced at least as much as the time required to access the NAND flash memory 300.

While performing the (e) operation, the prefetch controller 113 performs a value prefetch operation for the D-th next key from the current key.

If the current key is key #3 (that is, a key with an index of 3 in the pertinent second table), the value V5 corresponding to the key #5 is read and stored in the value buffer 150. In this case, the prefetched value V5 may be output when the fifth second command NEXT5 is executed.

Although various embodiments have been illustrated and described, various changes and modifications may be made to the described embodiments without departing from the spirit and scope of the invention as defined by the following claims. For example, in embodiments, the circuits described herein may include one or more processors and non-transient computer-readable media, and some operations described herein may be performed by the processors executing computer programming instructions stored on the non-transient computer-readable media.

What is claimed is:

1. A key-value (KV) based data storage device comprising:
a first memory configured to store a first table;
a second memory configured to store a Log-Structured Merge (LSM) tree area storing a plurality of second tables forming an LSM tree structure and to store a value log area storing a value corresponding to a key;
a key buffer configured to store one or more prefetched second tables corresponding to a key; and
a controller configured to control processing a range query command,
wherein the processing the range query command comprises:
performing a key prefetch operation when a number of unqueried keys in a first prefetched second table is smaller than a predetermined number, the key prefetch operation comprising reading from the second memory a second table adjacent in the LSM tree structure to the first prefetched second table and storing that adjacent second table as a second prefetched second table in the key buffer.

2. The KV based data storage device of claim 1, further comprising:
a value buffer,
wherein the controller processing the range query command further comprises:
reading a first value corresponding to a current key from the value buffer,
performing a value prefetch operation comprising reading a second value corresponding to a key having a predetermined distance from the current key from the value log area and storing the second value in the value buffer.

3. The KV based data storage device of claim 2, wherein the controller further comprises:
a dynamic random access memory (DRAM) controller configured to control the first memory, the first memory being a DRAM; and
a flash channel controller configured to control the second memory, the second memory being a NAND flash memory.

4. The KV based data storage device of claim 3, wherein the controller comprises:
a KV command processing circuit configured to process the range query command by controlling the DRAM controller and the flash channel controller to read a value corresponding to a key; and
a prefetch controller configured to perform the key prefetch operation and the value prefetch operation.

5. The KV based data storage device of claim 4, further comprising a host interface configured to extract the range query command by decoding a range query request sent from a host and a memory controller interface configured to provide a signal to the DRAM controller and to the flash channel controller.

6. The KV based data storage device of claim 1, wherein the range query command includes a first command corresponding to a key range and a plurality of second commands subsequent to the first command, and
wherein the controller processing the range query command comprises performing the first command by:
reading one or more second tables each including a respective key corresponding to the key range from the second memory,
storing the one or more second tables read from the second memory in the key buffer as one or more prefetched second tables,
searching the first table and the one or more prefetched second tables to determine a data offset corresponding to a start key which is most recently updated, the start key being a smallest key in the first table and the one or more prefetched second tables that is within the key range,
reading a value corresponding to the start key by using the data offset.

7. The KV based data storage device of claim 6, wherein the controller processing the range query command comprises performing the second command by:
selecting a target table among the one or more prefetched second tables stored in the key buffer wherein a number of additional keys searchable after a current key of the target table is smaller than a predetermined value,
reading a second table adjacent to the target table in the LSM tree structure from the second memory, and
storing the second table in the key buffer.

8. The KV based data storage device of claim 7, wherein the controller processing the range query command comprises performing the second command by reading a value corresponding to the current key in parallel with another operation performed in per performing the second command.

9. An operation method of a key-value (KV) based data storage device, the operation method comprising:
processing a first command to read a value corresponding to a start key corresponding to a range query command; and
processing a plurality of second commands subsequent to the first command to read values corresponding to a plurality of keys subsequent to the start key,
wherein processing the first command includes:
reading one or more second tables from a Log-Structured Merge (LSM) tree area in a second memory of the KV based storage device, the one or more second tables including respective start keys;
storing the one or more second tables as prefetched second tables in a key buffer of the KV based storage device;
determining a data offset corresponding to a start key in a first table in a first memory of the KV based storage device or in the one or more prefetched second tables stored in the key buffer; and
reading a first value corresponding to the data offset from a value log area in the second memory.

10. The operation method of claim 9, wherein processing a second command among the plurality of second commands comprises:
selecting a target table among the one or more prefetched second tables stored in the key buffer including a current key corresponding to the second command wherein a number of remaining keys searchable after the current key in the target table is smaller than a predetermined value;
reading an additional second table adjacent to the target table in the LSM tree area; and
storing the additional second table in the key buffer.

11. The operation method of claim 10, wherein processing the second command further comprises reading a second value corresponding to the current key in parallel to storing the additional second table.

12. The operation method of claim 11, wherein processing the second command further comprises reading a third value corresponding to a key separated from the current key by a predetermined distance from the value log area and storing the third value in a value buffer.

13. The operation method of claim 11, wherein reading the second value includes reading the second value from the value buffer.
